(19) United States
(12) Patent Application Publication
(10) Pub. No.: US 2025/0131113 A1
(43) Pub. Date: Apr. 24, 2025

(54) METHOD FOR MANAGING ACCESS TO MANIFESTS ASSOCIATED WITH CONTENT DISTRIBUTED IN REAL TIME

(71) Applicant: ORANGE, Issy-les-Moulineaux (FR)

(72) Inventors: Hervé MARCHAND, CHATILLON CEDEX (FR); Olivier GASTE, CHATILLON CEDEX (FR)

(21) Appl. No.: 18/920,160

(22) Filed: Oct. 18, 2024

(30) Foreign Application Priority Data
Oct. 18, 2023 (FR) 2311242

(51) Int. Cl. G06F 21/62; H04N 21/2387

(52) U.S. Cl. CPC G06F 21/6209; H04N 21/2387

(57) ABSTRACT

A method for managing access to manifests associated with content distributed in real time, playback of the content requiring receipt, from a communication network, of manifests of a first type or of a second type, a control interface being accessible during playback. The method includes an initial playback carried out by using manifests of the first type, and, during playback, a request for access to the manifest of the second type is transmitted if a command is selected, playback continuing by using manifests of the second type received from the network.

### CROSS REFERENCE TO RELATED APPLICATION

This application claims priority to and the benefit of French patent application n° FR 2311242, filed Oct. 18, 2023, the entire contents of which are incorporated herein by reference.

### TECHNICAL FIELD

The field of the disclosure is that of managing access to manifests associated with multimedia content distributed in real time.

The disclosure more particularly relates to content that is segmented into chunks, the chunks being accessible in a number of formats that are associated with respective sizes in bytes having a greater or lesser impact on the bandwidth of the network over which the content is downloaded. The disclosure more particularly relates to content downloaded using a technique called HTTP adaptive streaming, or HAS, or any other download technique using the same principle.

The addresses of the chunks are contained in a manifest. In the context of HTTP adaptive streaming, a manifest is a file containing, inter alia, the IP addresses of the chunks to be downloaded and played by a playback device.

The playback device is any data-processing device that is equipped with processors and capable of receiving chunks from a network, of decoding the received chunks and of requesting rendering of the decoded chunks.

### BACKGROUND

When multimedia content is accessed, a playback device sends a request to a content server indicating the chosen multimedia (video and/or audio) content. The playback device receives in response a digital data stream relating to this content. In the context of a local area communication network, such a request may transit via a network access gateway, for example a residential gateway.

The received data are then decoded by the playback device, before being rendered in the form of a display of the corresponding video with its associated soundtrack.

Distribution of digital content over the Internet is often based on client-server protocols of the HTTP family (HTTP standing for Hypertext Transport Protocol). In particular, streaming of digital content allows data to be transported and consumed in real time, i.e. the digital data are transmitted over the network and rendered by the playback device as they arrive. Following receipt of the stream, the playback device stores received data in a buffer memory before rendering them. This distribution mode is particularly useful when the bit rate available to the user is not guaranteed to be enough for real-time transfer of the video.

HTTP adaptive streaming, abbreviated HAS, additionally makes it possible to distribute and receive data with various qualities corresponding, for example, to various respective encoding rates. These various qualities are described in a description file, called the manifest by those skilled in the art.

When a user accesses a live stream distributed via HTTP adaptive streaming (HAS), the playback device successively retrieves at regular intervals, generally every two seconds, manifests that are referred to below as manifests of a first type, each of which generally describes the last sixty seconds of the stream (30 chunks of 2 seconds) by providing the addresses of chunks corresponding to these last sixty seconds.

It will be noted that the video chunks are chosen to be of short duration because it is desired to be as close to live as possible. It is also for this reason that the manifest is retrieved every two seconds and that the buffer depth is in general limited to about fifteen seconds.

It will be noted that an encoding rate is selected from the available rates depending on the available bandwidth or on the storage and decoding capacities of the playback device. This type of technique makes it possible to take into account variations in bandwidth on the link between the client playback device and the content server.

In addition to playback of content, certain playback devices offer a start-over function that allows a user watching content distributed in real time (a live channel) to replay some of the content that has already been distributed; this function in particular allows content to be replayed from the beginning. For example, if a movie starts at 9.00 pm and the user switches to the channel at 9.40 pm, the user may ask for playback of the content to restart from the beginning of the movie by selecting a dedicated command, for example via a remote control. In this case, a start-over mode is switched to from a real-time playback mode.

In this start-over mode, a control interface offers the ability to select one or more commands that modify playback of the content being distributed in real time. These commands make it possible, for example, to interrupt playback, or to skip back through the content to replay it from a prior playback time and therefore to play the content time-shifted.

In order to replay the content, contrary to the case referred to above in which only real-time playback was possible, when the start-over mode is available, the playback device receives, from the start of playback of the content, a specific manifest, referred to below as a manifest of a second type, which describes most of the chunks that have already been distributed. This manifest of the second type does not describe just the last sixty seconds but rather a larger time window of several hours, for example the last four hours, so as to allow content to be replayed from any time in the time window of four hours. Such a manifest describing, for example, the last four hours is two hundred and forty (240) times larger than a conventional manifest. Concretely, a manifest of the first type has a size of about 12 KB (description of 30 chunks of 2 seconds) and a manifest of the second type has a size of about 2.8 MB (description of 7200 chunks of 2 seconds).

Just like the manifest of the first type, this manifest of the second type is downloaded periodically, for example every two seconds.

Due to its enormous size, periodic transmission of the manifest of the second type occupies an enormous amount of network bandwidth, especially in the case of households equipped with a low-speed internet connection such as an ADSL connection; furthermore, such manifests require processing times (parsing times) that are excessively long and that may degrade normal playback of the content and cause the image to freeze in a manner unacceptable to a user.

Exemplary embodiments of the disclosure aims to improve the situation.

### SUMMARY

To this end, an exemplary embodiment of the disclosure relates to a method for managing access to manifests associated with content distributed in real time, playback of the content requiring receipt, from a communication network, of manifests of a first type or of a second type, a control interface being accessible during playback, characterized in that it comprises an initial playback carried out by means of manifests of the first type, and in that, during playback, a request for access to the manifest of the second type is transmitted if a command is selected, playback continuing by means of manifests of the second type received from the network.

According to an exemplary embodiment of the disclosure, although the playback interface offers commands requiring a manifest of the second type, playback starts with manifests of the first type; it is only after a command of the interface has been selected that the manifest of the second type is transmitted and used for playback of chunks by the playback device.

An exemplary embodiment of the disclosure delays the time of transmission of this manifest of the second type to after selection or execution of a command, i.e. to a time when there is a desire to modify the playback of the stream in real time. In the best possible case, no command is ever selected, for example because a user viewing the content has absolutely no intention of selecting and therefore executing a command of the interface; in this case, the bandwidth saving is maximum.

The result is a saving in bandwidth on the network conveying the manifests and a saving in CPU load until a command is selected, because the manifest received until the command is selected is a manifest of the first type that in the given example is smaller in size in bytes than the manifest of the second type. It will be noted that the disclosure could be applied to a manifest of the first type larger in size than a manifest of the second type.

According to a first embodiment of the method, receipt of the manifests of the second type ceases after a given length of time and is replaced by receipt of the manifest of the first file. When it is found, after execution of the command, that no other command has been selected for a given length of time, the managing entity again requests receipt of manifests of the first type. This embodiment allows CPU load to be reduced as soon as possible without adversely affecting user experience.

According to a particular second embodiment of the disclosure, which may be implemented alternatively to or cumulatively with the preceding embodiment, selection is followed by transmission of a request for access to the manifests of the second type and in that the selected command is executed after receipt of a manifest of the second type. This embodiment avoids executing a command while the manifest of the second type allowing execution of the command has not yet been received. According to one variant of this third mode, the selected command is executed after receipt of the first manifest of the second type.

According to a particular third embodiment of the disclosure, which may be implemented alternatively to or cumulatively with the preceding embodiment, the control interface comprises commands, certain of which cause time-shifted playback of the content; in this configuration, transmission of a request for access to the manifest of the second type is performed only for commands causing time-shifted playback. This embodiment allows transmission of manifests of the first type to continue despite selection of a command. This embodiment distinguishes between commands requiring and not requiring time-shifted playback.

According to a hardware aspect, the disclosure relates to an entity for managing access to manifests associated with content distributed in real time, playback of the content requiring receipt, from a communication network, of manifests of a first type or of a second type, a control interface being accessible during playback, characterized in that it comprises a playback module capable of initially playing back the content by means of manifests of the first type, and capable of, during playback, following selection of a command, triggering transmission of a request for access to the manifest of the second type, playback continuing by means of manifests of the second type received in response from the network.

According to another hardware aspect, the disclosure relates to a playback device comprising a managing entity such as defined above.

According to another hardware aspect, one subject of the disclosure is a computer program able to be implemented on a managing entity such as defined above, the program comprising code instructions that, when it is executed by a processor, carries out the steps of the managing method that are defined above.

According to another hardware aspect, one subject of the disclosure is a data medium on which at least one series of program-code instructions for executing a managing method such as defined above has been stored.

The medium in question may be any entity or device which is capable of storing the program. For example, the medium may comprise a storage means, such as a ROM, for example a CD-ROM or a microelectronic circuit ROM, or indeed a magnetic storage means, for example a hard disk. Moreover, the information medium may be a transmissible medium such as an electrical or optical signal, which may be routed via an electrical or optical cable, by radio or by other means. The program according to an exemplary embodiment of the disclosure may in particular be downloaded over the Internet. As an alternative, the information medium may be an integrated circuit into which the program is incorporated, the circuit being designed to execute or to be used in the execution of the method in question.

### BRIEF DESCRIPTION OF THE DRAWINGS

The present disclosure will be better understood on reading the following description, which is given by way of example and with reference to the appended drawings, in which:

FIG. 1 shows an architecture for streaming over the Internet based on the use of HTTP adaptive streaming according to one embodiment of the method of the disclosure;

FIG. 2 schematically illustrates the hardware structure of a server capable of transmitting manifests;

FIG. 3 schematically illustrates the hardware structure of a playback device capable of playing back multimedia streams in real time;

FIG. 4 illustrates content and the available chunks of this content;

FIG. 5 illustrates one embodiment of the method of the disclosure; this figure illustrates communication between the playback device and the content server and the type of manifests transmitted as a function of time;

FIG. 6 illustrates one possible variant of the preceding embodiment described with reference to FIG. 5.

### DETAILED DESCRIPTION OF ILLUSTRATIVE EMBODIMENTS OF THE DISCLOSURE

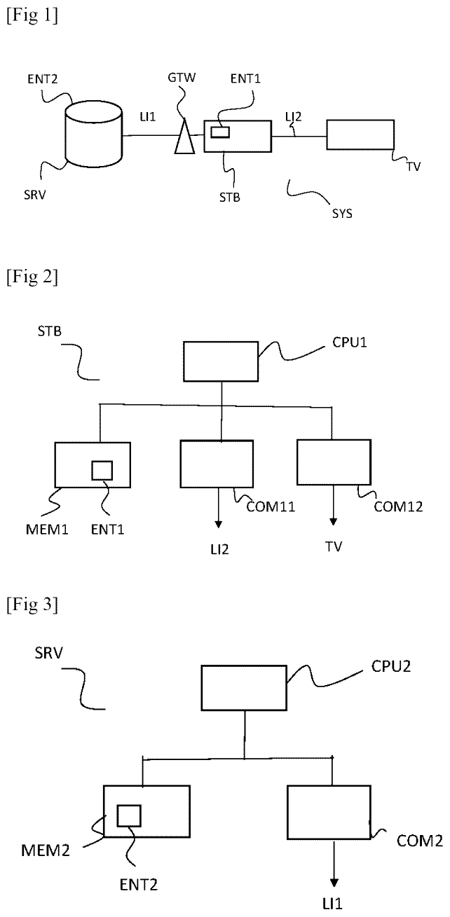

FIG. 1 shows an information-technology system SYS in which is implemented a content distribution network (CDN) from which are transmitted content to client devices or content playback devices and manifests associated with the multimedia contents.

In the given example, the system comprises a single playback device STB. However, the disclosure is applicable to any number of playback devices.

The playback device is for example a digital playback device such as a set-top box.

The multimedia content of which it is a question here is video content for example corresponding to a television channel broadcasting television programs having a start time corresponding to a scheduled broadcast time and an end time. The content in question is distributed in multicast mode.

In the given example, the playback device STB is connected to a rendering terminal TV such as a television.

In the given example, the playback device STB is connected to a port of the rendering device TV; the playback device playback device STB and the rendering device TV could also form one and the same device.

In the given example, the playback device STB is located in a local area network LAN managed by a residential gateway GTW. The context of the local area network is given by way of example and could easily be transposed to a best-effort Internet network, to a company network, etc. It will be seen below that the playback device STB comprises a first managing entity ENT1.

The gateway GTW is able to communicate via a telecommunications network LI1, such as a wide area network (WAN) known to those skilled in the art.

The information-technology system SYS implements a content distribution network (CDN) from which content is transmitted to client devices or content playback devices STB.

The CDN consists of servers that are networked in the wide area network; these servers interact in order to make multimedia content available to users in unicast mode. To simplify the description of the disclosure, the CDN has been represented in FIG. 1 by a single content server SRV. The content server SRV is located, in the given example, in the wide area network WAN.

The content server SRV for example receives channels of digital-television content from a television broadcast network (not shown) and makes them available to client terminals, here the playback device STB, in real time.

The content CNT is made available in unicast mode in a given format. Such content CNT is, for example, content streamed via HTTP adaptive streaming. The standard MPEG-DASH (DASH standing for Dynamic Adaptive Streaming over HTTP) is a standard format for distributing audiovisual over the Internet; this standard is based on preparing various representations of variable quality and bit rate of the content, which representations are segmented into chunks of short duration (of about a few seconds). Each of these chunks is made available individually by way of an exchange protocol between the rendering terminal and the server delivering the multimedia content. The protocol of which it mainly is a question is the HTTP protocol, but other protocols (for example FTP) may also be used. The organization of the chunks and the associated parameters are published in a manifest in XML format. The details of this streaming mode will not be described in further detail, because they are irrelevant to the description of the disclosure.

One example of a manifest (MPD) according to the MPEG-DASH standard and containing the description of content chunks of which are available in three different qualities (N1=512 kb/s, N2=1024 kb/s, N3=2048 kb/s) is given in Appendix 1. This simplified manifest describes digital content in an XML syntax (XML standing for extended Markup Language) and contains a list of content in the form of chunks that are conventionally described between a start tag (<SegmentList>) and an end tag (</SegmentList>). The segmentation into chunks in particular makes it possible to adapt finely to the fluctuations in bandwidth. Each chunk corresponds to a certain duration (duration field) with a plurality of quality levels, and allows their addresses (URL-Uniform Resource Locator) to be generated. This generation is performed in this example using “BaseURL” elements (“HTTP://server.com”) that indicate the address of the content server and “SegmentURL” elements that list the complementary portions of the addresses of the various chunks:
“C1_512kb_1.mp4” for the first chunk of the content “C1” at 512 kilobits per second (“kb”) in the format MPEG-4 (“mp4”),
“C1_512kb_2.mp4” for the second chunk,
etc.

With reference to FIG. 2, the server SRV is also equipped with at least one processor CPU2 and with memories MEM2 for carrying out information processing. The server is also equipped with a managing entity ENT2, called the second managing entity, able to manage transmission of content and of the associated manifest from the content of the server SRV to one or more playback devices, here to the playback device STB. The server SRV communicates with the gateway GTW via a wide area network (WAN). The server comprises, for communication with the WAN, a communication module referenced COM2 in FIG. 3. Transmission of the manifest rather than transmission of the chunks will be focused on below.

FIG. 3 shows an architecture of a playback device STB. This device STB comprises, as is conventional, memories MEM1 associated with a processor CPU1. The memories may be read-only memories (ROMs) or random-access memories (RAMs) or indeed flash memories.

The playback device STB may transmit content to be rendered to the rendering device TV via a communication module COM12. This module COM12 is for example an HDMI link.

The playback device STB communicates with the gateway via an Ethernet module for wired local communication or via a Wi-Fi radio module for wireless local communication with the residential gateway GTW. The module in question is referenced COM11 in FIG. 2.

The playback device STB comprises a streaming entity (not shown) able to manage streaming of chunks of the content. The playback device STB also comprises a managing entity ENT1, referred to as the first managing entity below, that is able to read a manifest constructed specifically during playback in start-over mode, as explained below.

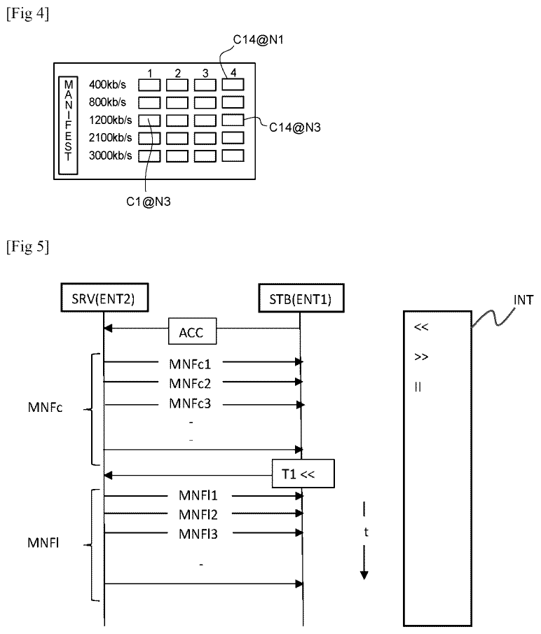

FIG. 4 shows a schematic view of main content C1 segmented into chunks and stored in the content server SRV. More precisely, the HAS content server contains a video C1 in the form of chunks C1i@Nj that are encoded at various encoding rates Nj, where the index i designates a temporal identifier of the chunk C1i@Nj.

The HAS streaming module, the HAS streaming mode being called the normal streaming mode below, of the playback device STB is responsible for retrieving the chunks from the HAS content server, while selecting the video quality Nj depending on the network resources available. The way in which the HAS streaming module selects the encoding rate of the next video chunk to be streamed is not described in more detail here: specifically, there are many algorithms allowing this selection to be made, the strategies of which are secure or aggressive to a greater or lesser extent. It will, however, be recalled that, more often than not, the general principle of such algorithms is based on streaming a first chunk at the lowest encoding rate proposed in the manifest, and on evaluating the time taken to retrieve this first chunk. On this basis, the HAS streaming module evaluates whether, depending on the size of the chunk and on the time taken to retrieve it, the network conditions allow the following chunk to be streamed at a higher encoding rate. Certain algorithms are based on a gradual increase in the quality level of the streamed chunks of content; others employ more risky approaches, with jumps in the levels of the rates at which successive chunks are encoded.

In the conventional case, if a video chunk lasts 3 seconds, it must not take the HAS streaming module more than 3 seconds to retrieve the chunk, in order to make it possible for the playback device STB to render the content without interruption. It is therefore necessary for the HAS streaming module to find the best compromise between the highest possible rendering quality, and therefore the highest possible encoding rate, and the time taken to stream the chunk, which must be short enough to allow continuous rendering on the television set TV.

Initially, the HAS module retrieves the manifest corresponding to the video content C1, in order to discover the available chunks of the video content C1, and the various associated video qualities Nj. In the example of FIG. 4, the content C1 is, for example, offered in the form of chunks of a duration of 3 s, with a first encoding rate N1=400 kb/s, a second encoding rate N2=800 kb/s, a third encoding rate N3=1200 kb/s, etc.

In a normal operating mode, which is not illustrated in FIG. 4, the HAS module for example streams successive chunks C11@N1 (i.e. the first time chunk at an encoding rate of 400 kb/s), then C12@N3 (i.e. the second time chunk at an encoding rate of 1200 kb/s), then C13@N3 (i.e. the third time chunk at an encoding rate of 1200 kb/s), etc.

The various chunks downloaded by the HAS streaming module are then transmitted to a display module which is able to request for them to be displayed on the screen of the television set TV.

The algorithm implemented by the HAS streaming module to determine which chunk must be streamed at which encoding rate in normal operating mode may be one of the algorithms already known in the prior art. This algorithm will therefore not be described in more detail here.

It happens that sometimes the start of a TV program (film, series, etc.) is missed. A function called “start over” or “restart” makes it possible, at any time, to restart the program in the process of being distributed at a time prior to the current time; for example, playback of the content may be restarted from its beginning. For example, if a movie starts at 9.00 pm and the user switches to the channel at 9.40 pm, she or he may ask for playback of the content to restart from the beginning of the movie. In this case, a time-shifted playback mode is therefore switched to from a real-time (or live) content playback mode.

When this user accesses a live stream distributed via HTTP adaptive streaming (HAS), the playback device STB, by which is implied the HAS entity installed on this device, retrieves, in general every 2 seconds, a manifest that generally describes the last 60 seconds of the stream (30 chunks of 2 seconds). The decision may then be made to buffer a certain part of the stream (up to 60 seconds at most therefore); the video chunks are of short duration because it is desired to be as close to live as possible. It is also for this reason that the manifest is retrieved every 2 seconds and that the buffer depth is in general limited to about 15 seconds.

A control interface (<< >>II) makes it possible to act on the current playback of the content. Commands allow the start-over mode to be activated.

In order to allow execution of a command of the control interface, the retrieved manifest no longer describes the last sixty seconds but a time window much larger than sixty seconds. The time window may relate to the last four hours; in this case, if the content may be read back from any time located in the time window.

This manifest describing the last four hours is transmitted periodically (generally every two seconds) regardless of whether the start-over mode is being used or not.

Below, manifests describing the last seconds (for example 60 seconds) will be designated “manifests of the first type” and will be referenced MNFc, and manifests describing a few hours (for example the last four hours) will be designated “manifests of the second type” and will be referenced MNFI. It will be understood that here the size of the manifest of the second type is greater than the size of the manifest of the first type.

According to an exemplary embodiment of the disclosure, the initial playback is performed by default by means of manifests of the first type MNFc. Subsequently, during playback, the type of manifest changes when a command is selected on the control interface; playback then continues by means of manifests of the second type MNFI received from the network.

FIG. 5 illustrates one embodiment of the method of the disclosure. FIG. 5 shows two vertical axes corresponding to two entities, namely the first entity ENT1 present in the playback device STB and the second entity ENT2 present in the server SRV, respectively. FIG. 5 illustrates the data exchanges that take place between the playback device STB and the content server. To the right of the two axes a box has been shown, to show which commands are available via a control interface INT throughout playback. Commands such as
a rewind command “<<”
a pause command “II”
and a fast-forward command “>>” feature therein (the fast-forward command may be used once playback has already been time-shifted).

It will be noted that in FIG. 5 only messages that are useful to comprehension of the disclosure have been illustrated. For example, after receipt of a manifest by the playback device STB, the latter requests access to the chunks described in this manifest; it has been chosen not to show these access messages because they are irrelevant to the description of the disclosure.

Execution of the commands given by way of example above causes time-shifted playback of the content in the process of being distributed. These commands therefore require access to chunks that are not described in the manifests of the first type, which relate to the latest chunks produced in the context of live distribution, in real time. The first entity ENT1 will therefore need to retrieve manifests of the second type, in order to be able to execute the commands correctly.

The steps of one embodiment may be as follows: it is assumed that the control interface comprises commands that cause time-shifted playback and that therefore require manifests of the second type.

In a first step, the first entity ENT1 requests access ACC to content.

In a second step, the server SRV and therefore the second entity ENT2 receives the request.

In a third step, the second entity ENT2 requests transmission, in the given example at regular intervals (for example every 2 seconds), of manifests of the first type MNFc (“c” designating manifests of the “short” or “cursory” first type). The various files are obviously different because they describe different chunks.

It will be noted that the manifest need not be sent with regularity. Other ways of transmitting the manifest may be envisaged.

With reference to FIG. 5, it is assumed that, at a time T1, a user selects the rewind command << on her or his remote control.

The set-top box STB receives the command <<. The first entity ENT1 receives the command.

At this stage, since the playback device STB does not have the manifest of the second type, it therefore does not have at its disposition the addresses of the requested chunks associated with the back-skipping resulting from the rewind command <<.

In the given example, following selection of the command, the first entity ENT1 transmits a request for access to the manifests of the second type.

The server SRV receives the request and successively transmits manifests of the second type MLFI instead of the manifests of the first type MLFC.

The first entity ENT1 receives in response the manifests of the second type MNFI (I designates the type of manifest “I” for long).

Once the first manifest of the second type MNFI1 has been received, the processor of the playback device STB executes the rewind command “<<” and is able to access the requested chunks by successively consulting the received manifests MNFI1/MNFI2/etc.

According to one variant, the first entity may execute the command not once the first file is received but once another manifest is received.

The embodiment described above may be subject to variants.

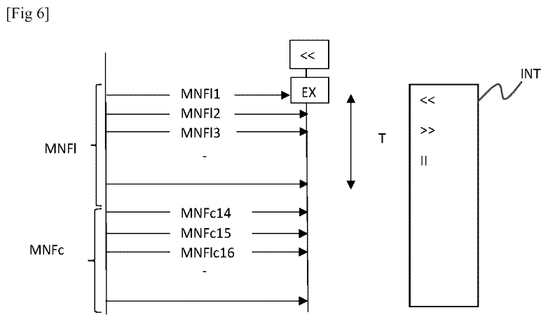

According to another variant, with reference to FIG. 6, the execution time EX of the command is judiciously chosen. In the given example, the first entity ENT1, after receipt of the selection of the command <<, delays execution of the command for a delay time. This delay allows the first entity ENT1 to transmit a request for access to the manifests of the second type MNFI, to receive the manifests of the second type in question and to execute the command to rewind to a chunk located in the interval of four hours preceding the current playback time.

According to one variant of the embodiment described above, with reference to FIG. 6, receipt of manifests of the second type ceases after a given length of time T, for example following selection or execution of the command, and is replaced by receipt again of the manifests of the first type.

Either of the first entity ENT1 and the second entity ENT2 may be the source of the replacement command.

As described above, the length of time T defined above may have as its initial time the execution EX of the command, as shown in FIG. 6.

According to a sub-variant, receipt of a new command during the length of time T resets the length of time T.

Essentially, an exemplary embodiment of the disclosure relates to a method for managing access to manifests associated with content distributed in real time (the manifests containing access addresses of chunks capable of being streamed and played by the chunk playback device STB), playback requiring receipt, from a communication network, of manifests of a first type MNFc or of a second type MNFI, a control interface INT being accessible during playback (as has been seen, execution of a command (<< >>) of the interface requires receipt of a manifest of the second type MNFI), characterized in that it comprises an initial playback carried out by means of manifests of the first type MNFc, and in that, during playback, a request for access to the manifest of the second type MNFI is transmitted if a command is selected, playback continuing by means of manifests of the second type received from the network.

It is specified lastly here that the term “entity” may correspond either to a software component or to a hardware component or to a set of software and hardware components, a software component itself corresponding to one or more computer programs or subroutines or, more generally, to any element of a program which is able to implement a function or a set of functions as described for the modules under consideration. In the same way, a hardware component corresponds to any element of a hardware assembly able to implement a function or a set of functions for the module in question (integrated circuit, chip card, memory card, etc.).

1. A management method comprising:
managing access to manifests associated with content distributed in real time, playback of the content requiring receipt, from a communication network, of manifests of a first type or of a second type, a control interface being accessible during playback, wherein the managing comprises:
performing an initial playback of the content, which is carried out by using at least one manifest of the first type, and
during playback, transmitting a request for access to at least one manifest of the second type in response to a command being selected, wherein the playback continues by using the at least one manifest of the second type received from the network.

2. The managing method according to claim 1, wherein receipt of at least one manifest of the second type ceases after a given length of time and is replaced by receipt of the manifest of the first type.

3. The managing method according to claim 1, wherein selection of the command is followed by the transmission of the request for access to at least one manifest of the second type and the selected command is executed after receipt of the at least one manifest of the second type.

4. The managing method according to claim 3, wherein the selected command is executed after receipt of a first manifest of the second type received.

5. The managing method according to claim 1, wherein the control interface comprises commands, certain of which cause time-shifted playback of the content, and wherein the request for access to at least one manifest of the second type is transmitted only for commands causing time-shifted playback.

6. An entity device comprising:
at least one processor; and
at least one non-transitory computer readable medium comprising instructions stored thereon which when executed by the at least one processor configure the entity device to manage access to manifests associated with content distributed in real time, playback of the content requiring receipt, from a communication network, of manifests of a first type or of a second type, a control interface being accessible during playback, wherein the managing comprises:
performing an initial a playback of the content, which is carried out by using at least one manifest of the first type, and
during playback, following selection of a command, triggering transmission of a request for access to at least one manifest of the second type, wherein the playback continues by using the at least one manifest of the second type received in response from the network.

7. A playback device comprising the entity as defined in claim 6.

8. A non-transitory computer readable medium comprising instructions stored thereon which when executed by at least one processor of a managing entity configure the managing entity to manage access to manifests associated with content distributed in real time, playback of the content requiring receipt, from a communication network, of manifests of a first type or of a second type, a control interface being accessible during playback, wherein the managing comprises:
performing an initial a playback of the content, which is carried out by using at least one manifest of the first type, and
during playback, following selection of a command, triggering transmission of a request for access to at least one manifest of the second type, wherein the playback continues by using the at least one manifest of the second type received in response from the network.
